(19) United States
(12) Patent Application Publication
(10) Pub. No.: US 2003/0088836 A1
(43) Pub. Date: May 8, 2003

(54) Low power test circuit and a semiconductor integrated circuit with the low power test circuit

(75) Inventors: Masahiro Kanazawa, Yokohama-shi (JP); Kimiyoshi Usami, Yokohama-shi (JP); Naoyuki Kawabe, Kawasaki-shi (JP); Takeshi Kitahara, Kawasaki-shi (JP)

Correspondence Address: OBLSON SPIVAK McCLELLAND MAIER & NEUSTADT, FOURTH FLOOR, 1755 JEFERSON DAVIS HIGHWAY, ARLINGTON, VA, 22202, US

(73) Assignee: KABUSHIKI KAISHA TOSHIBA, Tokyo (JP)

(21) Appl. No.: 10/282,137

(22) Filed: Oct. 29, 2002

(30) Foreign Application Priority Data
Nov. 5, 2001 (JP) P2001-339716

(51) Int. Cl. G06F 17/50

(52) U.S. Cl. 716/4

(57) ABSTRACT

A low power test circuit and a semiconductor integrated circuit are provided, i.e., the low power test circuit comprises a first stage single phase scan flip flop, a second stage single phase scan flip flop, a delay element located between an output terminal of the first stage single phase scan flip flop and an input terminal of the second stage single phase scan flip flop, a gate circuit connected between the output terminal of the first stage single phase scan flip flop and the delay element, and the gate circuit transferring scan data from the output terminal of the first stage single phase scan flip flop to the delay element in a scanning test mode thus reducing power dissipation in the delay element. The semiconductor integrated circuit comprises a shift register comprising a plurality of single phase scan flip flop serially connected and the low power test circuit.

### CROSS REFERENCE TO RELATED APPLICATIONS

This application is based upon and claims the benefit of priority from prior Japanese Patent Application P2001-339716 filed on Nov. 5, 2001; the entire contents of which are incorporated by reference herein.

### BACKGROUND OF THE INVENTION

1. Field of the Invention

The present invention relates to a low power test circuit for testing a semiconductor integrated circuit (IC) by means of serially connected Single-Clock Scan Flip Flops (F/Fs) and the semiconductor ICs including the low power test circuit.

2. Description of the Related Art

In a test design (Design-for-Test: DFT) for a semiconductor IC, there is a scan method of a shift register circuit, where plural F/Fs are connected in series in the semiconductor IC. As one of the types of F/F employed in this method (hereafter referred to as a single-phase scan F/F), there is a F/F as referred to as a Single-Clock Scan F/F. For example, this single-phase scan F/F is an F/F, which has no specific scan output terminal SO for scanning data.

In the scan method using such a serially connected single-phase scan F/Fs, a delay element is interconnected between the inverted output terminal QN of the first stage single-phase scan F/F and the test input terminal TI of the second stage single-phase scan F/F. The purpose of the delay element is to hold the SKEW between the first-stage and the second-stage of the single-phase scan F/F, which is derived from the clock SKEW of the clock signals given to the clock terminals CP in order to synchronize the single-phase scan F/Fs. This delay element encompasses a signal delay circuit, including an inverter chain having inverters connected in series and/or a buffer chain having buffer circuits connected in series or the like. It can include a wire capacitor element.

The purpose of the delay element is to adjust the input timing delay, when the output data from the output terminal QN of the first-stage single-phase scan F/F is fed to the test input terminal TI of the second-stage single-phase scan F/F. The delay element can give a delay time to the data signal timing from the output terminal Q and/or QN of the first-stage single-phase scan F/F in order to transfer and hold the data precisely to the input terminal TI of the second-stage single-phase scan F/F.

In such a constitution, the charging and discharging mode of the delay element is normally operated repeatedly, because the output voltage shown at the output terminals Q and QN varies according to the switching operation of the single-phase scan F/F in normal mode, that is, in non-scanning test mode of the single-phase scan F/Fs connected in series.

Therefore, the amount of power consumption is increased remarkably, because the charging and discharging operations of each delay element located between single-phase scan F/Fs occur repeatedly in normal mode.

On the other hand, there is a type of single-phase scan F/F, where the buffer delay element or the like is interconnected previously to the test input terminal TI in the single-phase scan F/F. It can be called “a single-phase scan F/F for hold violation”. However, the charging and discharging operations occur for the wire capacitor in the wire line connecting the output terminal Q or QN of the first-stage single-phase scan F/F and the test input terminal TI of the second-stage single-phase scan F/F. And also charging and discharging operations occur for the buffer circuit connected to the test input terminal TI in the single-phase scan F/F. Therefore, power is excessively dissipated.

As discussed above, in the DFT of the semiconductor IC using the single-phase scan F/Fs, there is a delay element for hold violation between the single-phase scan F/Fs connected in series. Because of this, the delay element is charged and discharged in normal mode. Therefore, it is inconvenient to operate such a test circuit due to the increased power consumption.

### SUMMARY OF THE INVENTION

The present invention relates to a low power test circuit comprising, a first stage single phase scan flip flop, a second stage single phase scan flip flop, a delay element located between an output terminal of the first stage single phase scan flip flop and an input terminal of the second stage single phase scan flip flop, and a gate circuit connected between the output terminal of the first stage single phase scan flip flop and the delay element.

The present invention relates to a low power test circuit comprising, a first stage single phase scan flip flop, a second stage single phase scan flip flop, a delay element located between an output terminal of the first stage single phase scan flip flop and an input terminal of the second stage single phase scan flip flop, a gate circuit connected between the output terminal of the first stage single phase scan flip flop and the delay element, and the gate circuit transferring scan data from the output terminal of the first stage single phase scan flip flop to the delay element in a scanning test mode, thus reducing power dissipation in the delay element.

The present invention relates to a semiconductor integrated circuit with a low power test circuit comprising, (a) a shift register comprising a plurality of single phase scan flip flops serially connected, and (b) a low power test circuit comprising a first-stage single phase scan flip flop, a second stage single phase scan flip flop, a delay element located between an output terminal of the first stage single phase scan flip flop and an input terminal of the second stage single phase scan flip flop, a gate circuit connected between the output terminal of the first stage single phase scan flip flop and the delay element.

### BRIEF DESCRIPTION OF DRAWINGS

FIG. 1 shows a schematic diagram of a low power test circuit as a comparative example.

FIG. 2 shows a schematic diagram of a chain of single-phase scan F/Fs serially connected in the testing semiconductor IC as a comparative example.

FIG. 3 shows a schematic diagram of a semiconductor IC related to the first embodiment of the present invention which includes low power test circuits of the present invention in one part of the constitutional element in the serially connected single-phase scan F/Fs.

FIG. 4 shows a schematic circuit diagram of a low power test circuit related to the second embodiment of the present invention.

FIG. 5 indicates a concrete circuit structure of a single-phase scan F/F using a D type F/F, according to the modified example of the second embodiment of the present invention.

FIG. 6 shows a concrete circuit structure of a single-phase scan F/F using a D type F/F with a reset terminal, according to the other modified example of the second embodiment of the present invention.

FIG. 7A shows a schematic diagram of a truth table of the D type F/F.

FIG. 7B shows a schematic diagram of a truth table of the D type F/F with a reset terminal.

FIG. 8A shows a circuit representation of an inverter comprising a delay element in the low power test circuit of the present invention.

FIG. 8B shows a circuit representation of two stage inverters consisting a delay element in the low power test circuit of the present invention.

FIG. 8C shows a circuit representation of a buffer circuit comprising a delay element in the low power test circuit of the present invention.

FIG. 8D shows a circuit representation of a buffer circuit comprising two stages of inverters, consisting of a delay element in the low power test circuit of the present invention.

FIG. 9A shows a schematic representation of a delay element employed in a low power test circuit of the present invention.

FIG. 9B shows a schematic representation of serially connected inverter chain as a delay element employed in a low power test circuit of the present invention.

FIG. 10A shows a schematic circuit diagram of a serially connected single-phase scan F/F 11X and single-phase scan F/F 12Y.

FIG. 10B shows a circuit diagram of a serially connected single-phase scan F/F 11X and 12Y and a delay element between them.

FIG. 11A shows a schematic circuit diagram of a low power test circuit as a comparative example, and, in the single-phase scan F/F 90 of FIG. 1, which composes the adverse connection of Q and QN.

FIG. 11B shows a schematic circuit diagram of a low power test circuit of the third embodiment of the present invention.

FIG. 12 shows a schematic circuit diagram of a low power test circuit of the fourth embodiment of the present invention.

FIG. 13 shows a schematic circuit diagram of a low power test circuit of the fifth embodiment of the present invention.

FIG. 14 shows a schematic circuit diagram of a low power test circuit of the sixth embodiment of the present invention.

FIG. 15 shows a schematic circuit diagram of a low power test circuit of the seventh embodiment of the present invention.

FIG. 16 shows a schematic circuit diagram of a low power test circuit of the eighth embodiment of the present invention.

FIG. 17 shows a schematic circuit diagram of a low power test circuit of the ninth embodiment of the present invention.

FIG. 18 shows a schematic circuit diagram of a low power test circuit of the tenth embodiment of the present invention.

FIG. 19 shows a schematic circuit diagram of a low power test circuit of the eleventh embodiment of the present invention.

FIG. 20 shows a schematic circuit diagram of a low power test circuit of the twelfth embodiment of the present invention.

FIG. 21 shows a schematic circuit diagram of a low power test circuit of the thirteenth embodiment of the present invention.

FIG. 22 shows a schematic circuit diagram of a low power test circuit of the fourteenth embodiment of the present invention.

### DETAILED DESCRIPTION OF THE EMBODIMENTS

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Generally and as is conventional in the representation of the circuit blocks, it will be appreciated that the various drawings are not drawn to scale from one figure to another nor within a given figure, and in particular that the circuit diagrams are drawn arbitrarily to facilitate the reading of the drawings.

In the following descriptions, numerous specific details are set fourth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention with unnecessary detail.

### COMPARATIVE EXAMPLE

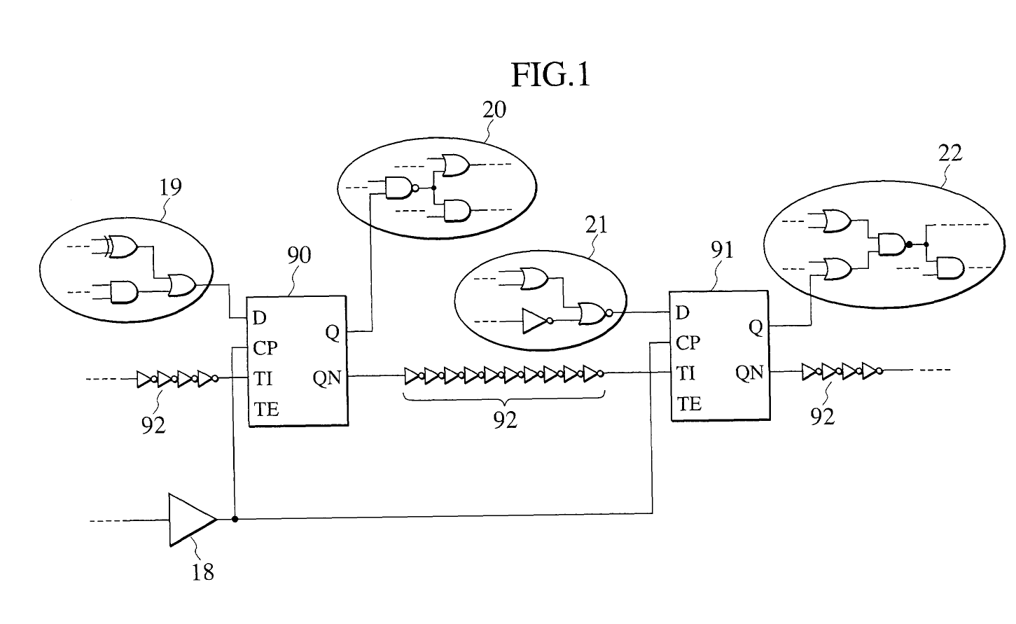

As shown in FIG. 1, a low power test circuit of a comparative example of the present invention has a delay element 92 between the inverted output terminal QN of the first-stage single-phase scan F/F 90 and the test input terminal TI of the second-stage single-phase scan F/F 91 in order to reduce the occurrence of hold time violation. A role of the delay element 92 for holding violation is to compensate for a SKEW of a clock signal given on a clock terminal CP from a buffer circuit 18 in order to synchronize the single-phase scan F/Fs 90 and 91. This delay element 92 encompasses the signal delay circuit, which can be embraced by an inverter chain of the serially connected inverters and/or a buffer chain of the serially connected buffers or the like. It can be also composed of a wire capacitor element. The purpose of the delay element 92 is to adjust the input timing delay, when the output data from the output terminal QN of the first-stage single-phase scan F/F 90 is fed to the test input terminal of the second-stage single-phase scan F/F 91. The delay element 92 can give a delay time to the data signal timing from the output data of the first-stage single-phase scan F/F 90 in order to transfer and store the data precisely in the input terminal TI of the second-stage single-phase scan F/F91.

As shown in FIG. 1, a first logic circuit 19 to compose a peripheral circuit is connected to the delay terminal D of the first-stage single-phase scan F/F 90. For example, the first logic circuit 19 is a circuit including an exclusive OR gate, an AND gate and an OR gate such as shown in FIG. 1. A second logic circuit 20 that composes another peripheral circuit is connected to a Q output terminal. For example, the second logic circuit 20 is a circuit including a NAND gate, an AND gate and an OR gate. Similarly, a third logic circuit 21 that composes still another peripheral circuit is connected to a delay terminal D of the second-stage single-phase scan F/F 91 such as is shown in FIG. 1. For example, the third logic circuit 21 is a circuit including an OR gate, an inverter and a NOR gate such as shown in FIG. 1. In addition, a fourth logic circuit 22 that composes still another peripheral circuit is connected to an output terminal Q of the second-stage single-phase scan F/F 91. For example, the fourth logic circuit 22 is a circuit including an OR gate and an AND gate such as is shown in FIG. 1.

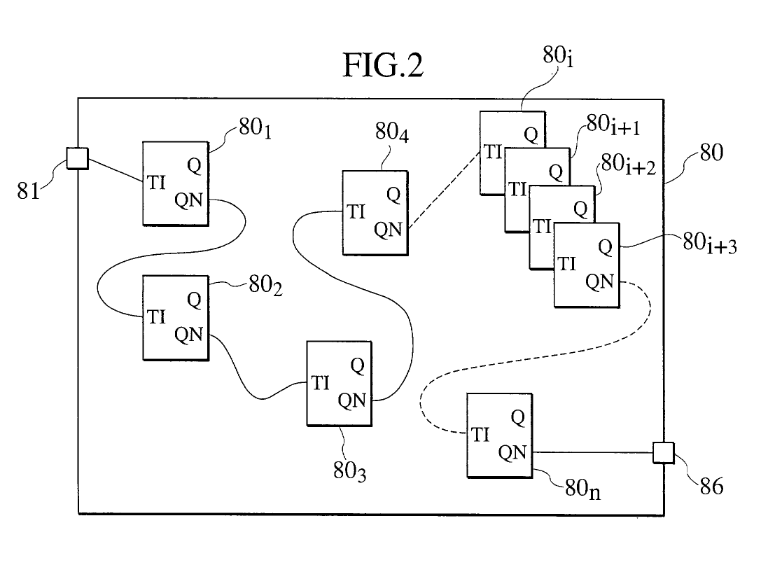

FIG. 2 shows a schematic diagram of a chain of single-phase scan F/Fs serially connected in the testing semiconductor IC as a comparative example. In the semiconductor IC 80 having scanning input terminal 81 and scanning output terminal 86, a plurality of single-phase scan F/Fs 80₁, 80₂, 80₃, 80₄, . . . 80ᵢ, 80ᵢ₊₁, 80ᵢ₊₂, 80ᵢ₊₃, . . . , 80ₙ are serially connected and disposed.

For example, in the DFT of the semiconductor IC 80, the scanning input terminal 81 of the semiconductor IC 80 is connected to a test input terminal TI of single-phase scan F/F 80₁ of the first-stage as shown in FIG. 2. The inverted output terminal QN of the single-phase scan F/F 80₁ is connected to the test input terminal TI of the second-stage single-phase scan F/F 80₂. In FIG. 2, the output terminal Q can be connected serially. The similar converted configuration between the output terminal QN and Q can be hold in the following description.

Furthermore, the output terminal QN of the second-stage single-phase scan F/F 80₂ is connected to a test input terminal TI of a third-stage single-phase scan F/F 80₃. All single-phase scan F/Fs are connected serially in this way. The inverted output terminal QN of the last-stage single-phase scan F/F 80ₙ is connected to the scanning output terminal 86 of the semiconductor IC 80. As an example, the inverted output terminal QN of the preceding stage and the test input terminal TI of the next stage are mutually connected in FIG. 2, but the output terminal Q and the test input terminal TI of the next stage may be connected, in the following description of the embodiment.

In the scanning connection of such single-phase scan F/Fs, the output data provided from the first-stage are transferred to the test input terminal TI of the second-stage, furthermore, the data is transferred to the third-stage single-phase scan F/F through the test input terminal TI and delivered from the output terminal Q and/or QN. Such signal propagation is done in each single-phase scan F/Fs. Because of this, the scanning data given in the scanning test input terminal 81 is serially shifted through the single-phase scan F/Fs, the data set and stored in the single-phase scan F/F is serially shifted and finally shifted to the scanning output terminal 86 of the semiconductor IC 80 and delivered to the external of the semiconductor IC.

First Embodiment

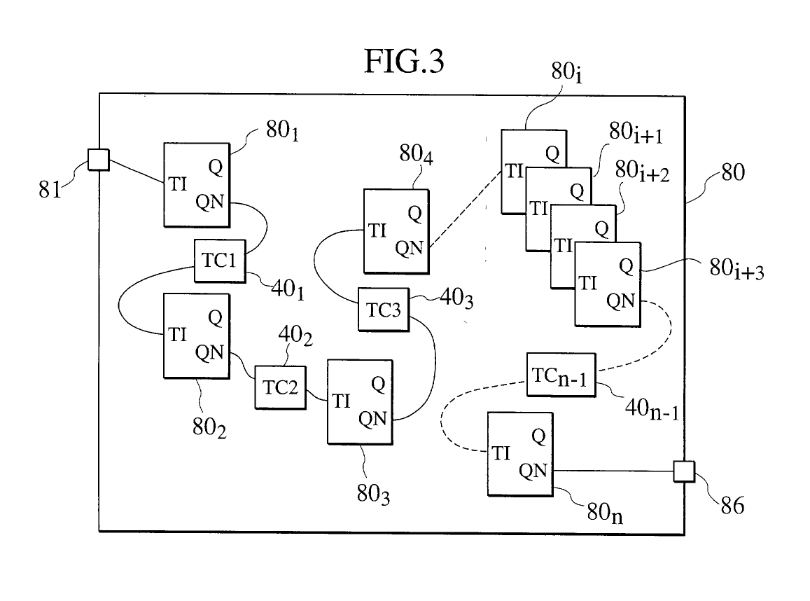

The semiconductor IC 80 relating to the first embodiment of the present invention includes low power test circuits TC1 40₁, TC2 40₂, TC3 40₃, . . . TCn-1 40ₙ as a part of the constitutional element in the serially connected chain of the single-phase scan F/Fs 80₁, 80₂, 80₃, 80₄, . . . 80ᵢ, 80ᵢ₊₁, 80ᵢ₊₂, 80ᵢ₊₃, . . . 80ₙ in the testing semiconductor IC 80, as shown in FIG. 3. The low power test circuit TC1 40₁ is connected between a first-stage single-phase scan F/F 80₁ and a second-stage single-phase scan F/F 80₂, the low power test circuit TC2 40₂ is connected between the second-stage single-phase scan F/F 80₂ and a third-stage single-phase scan F/F 80₃, the low power test circuit TC3 40₃ is connected between the third-stage single phase scan F/F 80₃ and a fourth-stage single-phase scan F/F 80₄, . . . and a low power test circuit TCn-1 is connected between the single-phase scan F/F 80ₙ₋₁ and a last-stage single-phase scan F/F 80ₙ.

Such a low power test circuit may be connected between a single-phase scan F/F and the next-stage single-phase scan F/F, and may be included in a part of the semiconductor IC. In comparison with a comparative example of FIG. 2, there is a difference with FIG. 3, according to the first embodiment of the present invention, in that low power test circuits TC1 40₁, TC2 40₂, TC3 40₃ . . . and TCn-1 40ₙ₋₁ are included in between single-phase scan F/Fs chain.

As for the low power test circuit in FIG. 3, following all the circuits according from the second embodiment to the fourteenth embodiment of the present invention may well be employed. The semiconductor IC, which encompasses such a low power test circuit as one of the elements, is an important aspect of the present invention.

In FIG. 3, each low power circuit, such as TC1 40₁, TC2 40₂, TC3 40₃, . . . , TCn-1 40ₙ₋₁, encompasses a switching element and a delay element connected to the switching element. As a switching element, an AND gate, a NAND gate, an OR gate, a NOR gate or a combined circuit of these gate circuits with an inverter may be employed.

In normal mode of the low power test circuit of the present invention, such as a test mode operation, the delay element in the test circuit is charged and discharged by the switching operation.

In non-testing mode, such as a no-scanning mode, the charging and discharging effect of the delay element is fully suppressed, because of the switching of the gate circuit.

Therefore, low-power operation of the test circuit of the present invention can be realized. The concrete constitution of a low power test circuit will become clear by means of the following description of the embodiment.

Second Embodiment

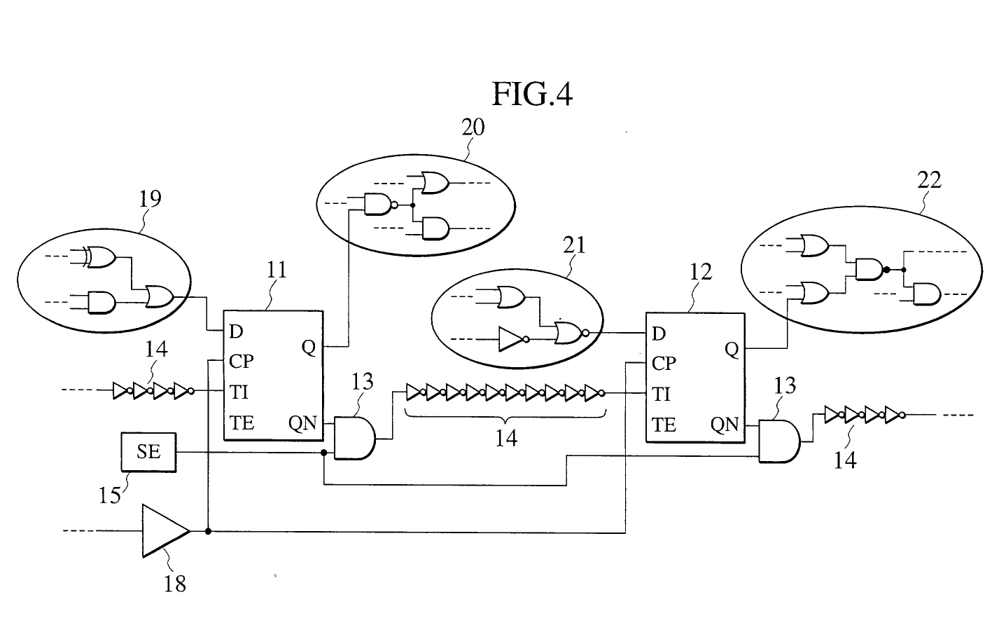

According to the second embodiment of the present invention, a low power test circuit is composed of multi-stages of single-phase scan F/Fs serially connected to realize a shift register, as shown in FIG. 4. If the multi-stages of the single-phase scan F/Fs are represented by the connection of a first-stage single-phase scan F/F 11 and a second-stage single-phase scan F/F 12, the first-stage single-phase scan F/F 11 is connected to the second-stage single-phase scan F/F 12 with an AND gate 13 and a delay element 14 in order to reduce the occurrence of hold time violation, as is shown in FIG. 4. A first gate circuit 19 is connected to a delay terminal D of the first-stage single-phase scan F/F 11. A second gate circuit 20 is connected to an output terminal Q of the first-stage single-phase scan F/F 11. A third gate circuit 21 is connected to a delay terminal D of the second-stage single-phase scan F/F 12. A fourth gate circuit 22 is connected to an output terminal Q of the second-stage single-phase scan F/F 12.

For example, the first logic circuit 19 is a circuit including an exclusive OR gate, an AND gate and an OR gate such as shown in FIG. 4. The second logic circuit 20 is a circuit including a NAND gate, an AND gate and an OR gate. Similarly, for example, the third logic circuit 21 is a circuit including an OR gate, an inverter and a NOR gate such as shown in FIG. 4. In addition, for example, the fourth logic circuit 22 is a circuit including an OR gate and an AND gate such as is shown in FIG. 4. The each circuit representation of the logic gate circuit 19, 20, 21 and 22 is a representative circuit diagram, and it is clearly not limited to this.

A clock signal occurring from buffer circuit 18 is commonly transferred to a clock input terminal CP of the each single-phase scan F/F 11, 12, such as is shown in FIG. 4.

The inverted output terminal QN of the first-stage single-phase scan F/F 11 is connected to the test input terminal TI of the second-stage single-phase scan F/F 12 through an AND gate 13 and a delay element 14.

In the same way, the inverted output terminal QN of the second-stage single-phase scan F/F 12 is connected to the test input terminal TI of the next stage single-phase scan F/F through an AND gate 13 and a delay element 14. A signal from a scan enable terminal SE 15 is commonly given to one of the inputs of the AND gate 13.

The AND gate 13 can be switched in response to the signal level from the scan enable terminal SE, the value of the power dissipation in the delay element 14 can be reduced remarkably.

In the scanning mode of the test circuit, such as a normal mode, the level of the scan enable signal becomes SE=1, thus leading to accompanied power dissipation in the delay element 14 due to the charging and discharging effect. On the other hand, in the non-scanning mode of the test circuit, such as a non-testing mode, the level of the scan enable signal becomes SE=0, thus leading to gating-off of the AND gate 13 so that there is no power dissipation in the delay element 14.

As shown in FIG. 4, there is provided, in the single-phase scan F/Fs 11,12, a delay terminal D for receiving an input data in normal mode, a clock input terminal CP for receiving a clock signal for the system synchronization, a test enable terminal TE for receiving an instruction command to normal mode and/or test-scanning mode, a test input terminal TI for receiving scan data from an output terminal of the former stage single-phase scan F/F in scanning test mode, and an output terminal Q and an inverted output terminal QN for transferring the received and stored data in the single-phase scan F/F 11, 12.

The single-phase scan F/F 11, 12 can be enabled in normal mode, when a low level signal is provided on a test enable terminal TE. Or the scan data, which is scan shifted and held in the single-phase scan F/F 11, 12, is given to the test target in normal test mode. In such a test vector mode, the stored data in the single-phase scan F/F 11, 12 can be delivered from the output terminal Q in synchronization with the clock signal. On the other hand, for example, the single-phase scan F/F 11, 12 can be enabled in the test-scanning mode, when a high level signal is provided on a test enable terminal TE. In such a test scanning mode, the scanning data given from the test input terminal TI is delivered from the inverted output terminal QN of the single-phase scan F/F.

As shown in FIG. 4, an inverted output terminal QN is connected to one of the input terminals of the AND gate 13. The scan enable terminal SE 15, that the signal which distinguishes the other mode from the test-scanning mode, is connected to the other input terminal of the AND gate 13. The output terminal of the AND gate 13 is connected to the input of the delay element 14 in order to reduce the occurrence of hold time violation, as mentioned above. The output of the delay element 14 is connected to the test input terminal TI of the next stage single-phase scan F/F 11, 12.

In such a constitution of the low power test circuit in the second embodiment of the present invention, a high level signal SE=1 is provided to the scan enable terminal SE 15, in normal scanning test mode. In this situation, the scanning data provided about test input terminal TI is delivered from the inverted output terminal QN of the single-phase scan F/F 11. The scanning output data delivered from the inverted output terminal QN is provided to and stored in the test input terminal TI of the next stage single-phase scan F/F 12 through an AND gate 13 and a delay element 14. This operation is practiced repeatedly in phase with the clock signal input, and the scanning data is shifted and transferred to the multi-stages of the single-phase scan F/Fs.

On the other hand, a low level signal SE=0 is provided to the scan enable terminal SE 15, in non-scanning mode. In this situation, the single-phase scan F/F 11, 12 is operated to transfer stored data from the inverted output terminal QN. And, even if the data from the inverted output terminal QN is given to the input terminal of the AND gate 13, the potential of the other input terminal of the AND gate 13 is maintained at a low level. Therefore, when the single-phase scan F/F 11, 12 is operated in non-scanning mode other than normal scanning test mode, the delay element 14 is isolated from the scanning circuits and in out-of-working mode. In addition, there is no charging and discharging operation of the wire capacitor.

Because of this, as compared with the comparative example of FIG. 1, where the delay element is charged and discharged even in non-scanning mode, the amount of the overall power dissipation can be greatly reduced, and a low-power test circuit can be realized.

As shown in FIG. 4, an AND gate 13 is interposed between the single-phase scan F/F 11 and a delay element 14 so as to transfer scanning data to the delay element 14 via the AND gate 13 in test mode and/or in test scanning mode. Therefore, there is no power dissipation in the delay element 14 in non-testing mode and/or in non-scanning mode, so that a low power test circuit can be realized.

In addition, in the second embodiment of the present invention, a signal given to the other input terminal of the AND gate 13 may be the same signal as a signal given to the test enable terminal TE of the single-phase scan F/F 11 and 12. Moreover, a low level signal SE=0 may well be provided to the scan enable terminal SE 15 in normal mode and a high level signal SE=1 may well be given to the scan enable terminal SE 15 in scanning test mode. Such a control mode of operation is very effective when it is difficult to distinguish scanning mode from other modes of operation.

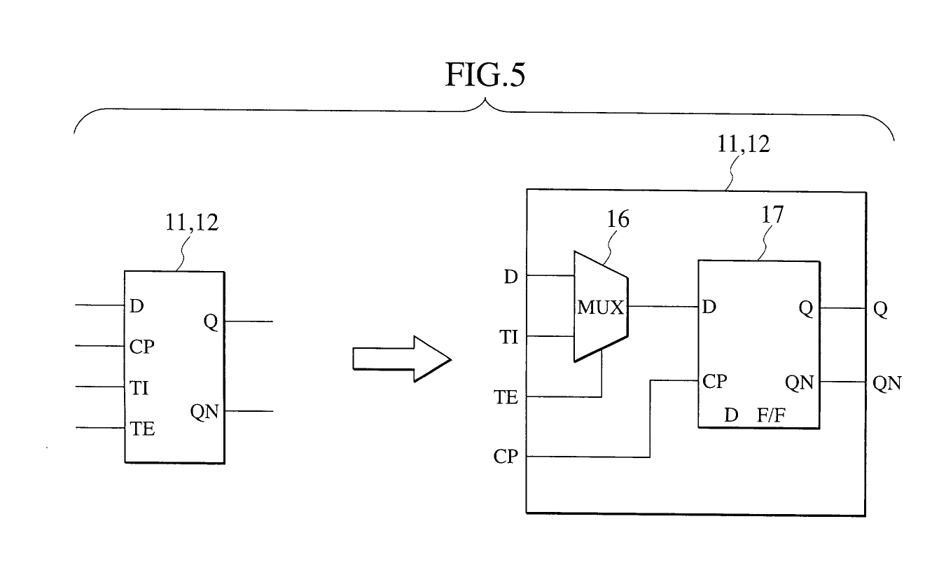

FIG. 5 relates to a modified example of the second embodiment of the present invention and shows the schematics of a concrete structure of the single-phase scan F/F to realize a low power test circuit by means of a D type F/F.

As shown in FIG. 5, for example, the single-phase scan F/F 11, 12 encompasses a multiplexer (MUX) 16 and a D type F/F 17. The delay terminal D and the test input terminal TI of the single-phase scan F/F 11, 12 correspond to the input terminal D and the test input terminal TI of the multiplexer (MUX) 16, respectively. The test enable terminal TE of the single-phase scan F/Fs 11, 12 provides a signal to the multiplexer (MUX) 16 in order to select the input terminal D and the test input terminal TI of the multiplexer (MUX) 16 according to the test enable signal provided by the test enable terminal TE of the single-phase scan F/F 11, 12. The input terminal D of the D type F/F 17 is connected to the output of the multiplexer (MUX) 16, the clock terminal CP of the D type F/F 17 is connected to the clock terminal CP of the single-phase scan F/F 11, 12, and the output terminal Q, QN of the D type F/F 17 corresponds to the output terminal Q, QN of the single-phase scan F/F 11, 12, respectively.

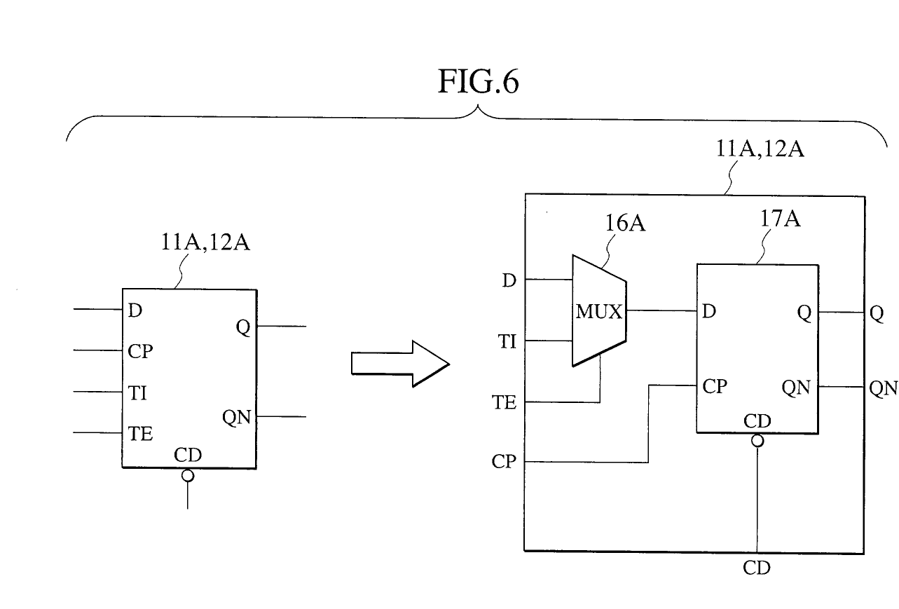

FIG. 6 relates to a modified example of the second embodiment of the present invention and shows the schematics of a concrete structure of the single-phase scan F/F to realize a low power test circuit by means of a D type F/F with a reset terminal CD. That is, the single-phase scan F/F 11A, 12A is disclosed as a single-phase scan F/F with a clear terminal or with a reset terminal CD. It may be referred to as “a Single-Clock Scan F/F with Clear”. As shown in FIG. 6, there is a clear terminal or a reset terminal CD in the Single-Clock Scan F/F with Clear 11A, 12A.

As shown in FIG. 6, for example, the Single-Clock Scan F/F with Clear 11A, 12A encompasses a multiplexer (MUX) 16A and a D type F/F17A. The delay terminal D and the test input terminal TI of the Single-Clock Scan F/F with Clear 11A, 12A corresponds to the input terminal D and the test input terminal TI of the multiplexer (MUX) 16A, respectively. The test enable terminal TE of the Single-Clock Scan F/F with Clear 11A, 12A is given to the multiplexer (MUX) 16A in order to select the input terminal D and the test input terminal TI of the multiplexer (MUX) 16A according to the test enable signal given from the test enable terminal TE of the Single-Clock Scan F/F with Clear 11A, 12A. The input terminal D of the D type F/F 17A is connected to the output of the multiplexer (MUX) 16A, the clock terminal CP of the D type F/F 17A is connected to the clock terminal CP of the Single-Clock Scan Flip Flop with Clear 11A, 12A, and the output terminal Q, QN of the D type F/F 17A correspond to the output terminal Q, QN of the Single-Clock Scan Flip Flop with Clear 11A, 12A, respectively.

The clear terminal CD of the D type F/F 17A is directly connected to the clear terminal CD of the Single-Clock Scan F/F with Clear 11A, 12A. The feature of the FIG. 6 is in the clear terminal CD of Single-Clock Scan F/F with Clear 11A, 12A. The other circuit structure in FIG. 6 is similar to the circuit structure in FIG. 5.

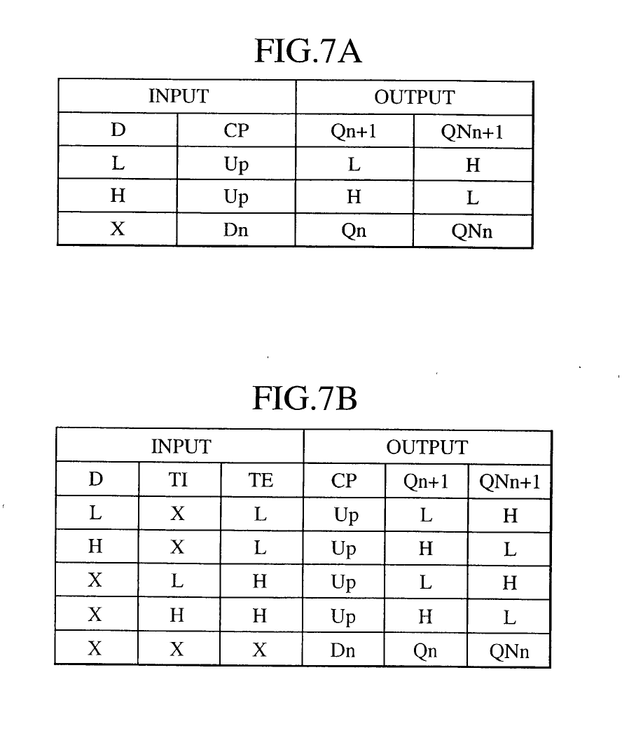

A truth table of a D type F/F is shown in FIG. 7A. In addition, a truth table of a scan D type F/F is shown in FIG. 7B.

A D type F/F is equivalent to the F/F, which is shown at 17, 17A in FIG. 5, FIG. 6 respectively here. In addition, it is equivalent to the F/F, which is shown at 11,12, 11A, 12A in FIG. 5, FIG. 6 respectively with scan D type F/F. In FIG. 7A and FIG. 7B, the rising-up operation from L to H of a clock pulse CP is represented by Up in FIG. 7A and FIG. 7B, and the falling-down operation from H to L is represented by Dn. A state X means an unspecified state. The D type F/F can be substituted for the scan D type F/F. The test enable signal from the test enable terminal TE can select an input data from the delay terminal D in normal mode. In serial shift mode, a test enable signal on the TE terminal can select data from the test input terminal TI. This test input comes from the Q, QN output terminal of the previous F/F in the scan path. A clock input into the common clock terminal CP is employed as a clock for the system and scan clocks.

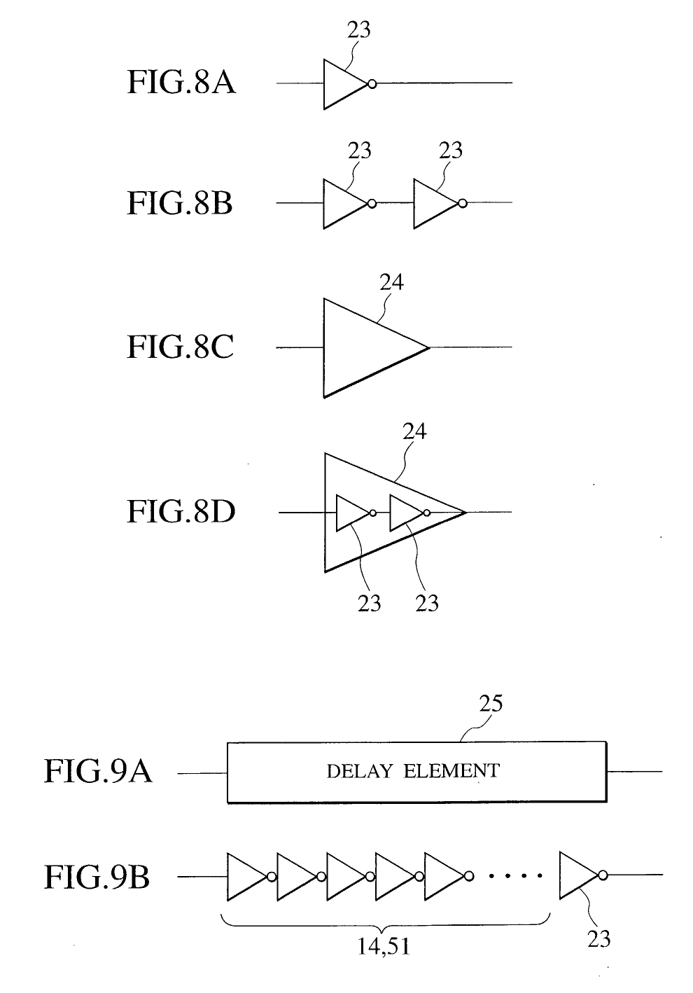

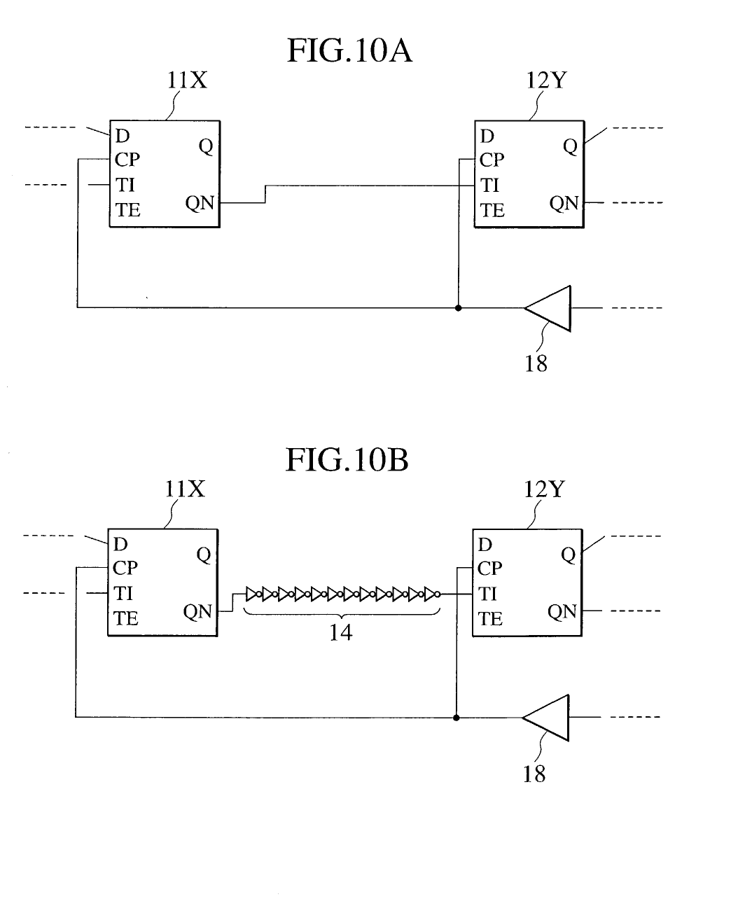

FIGS. 8A to 8D concretely show an element including the delay element 14. FIG. 8A shows a circuit diagram of an inverter. The delay line can compose multi-staging of an inverter. FIG. 8B shows a circuit diagram of a buffer circuit. The buffer circuit shows the circuit representation where two inverters are connected in series. FIG. 8C shows the circuit representation of one stage buffer circuit. Practically, the circuit representation shown in FIG. 8C is equivalent to the circuit representation shown in FIG. 8B. FIG. 8D shows a buffer circuit including two inverters connected in series. The circuit representation shown in FIG. 8D is substantially equivalent to the circuit representation shown in FIG. 8C. It explains how the buffer, a circuit element as referred to as an inverter was expressed concretely here. In the first embodiment of the present invention shown in FIG. 4, for delay element 14, an example encompassing ten stages of inverter chains is disclosed. More generally, this may be replaced by any kind of delay element. Considering the circumstances, a delay element is illustrated more generally, as in FIG. 9A and FIG. 9B. The FIG. 9A shows a general delay element 25. If it has a delay function, an arbitrary constitution can be applied to the structure of the delay element 25. FIG. 9B shows an inverter chain 14, 51 having a plurality of inverters 23 connected in series.

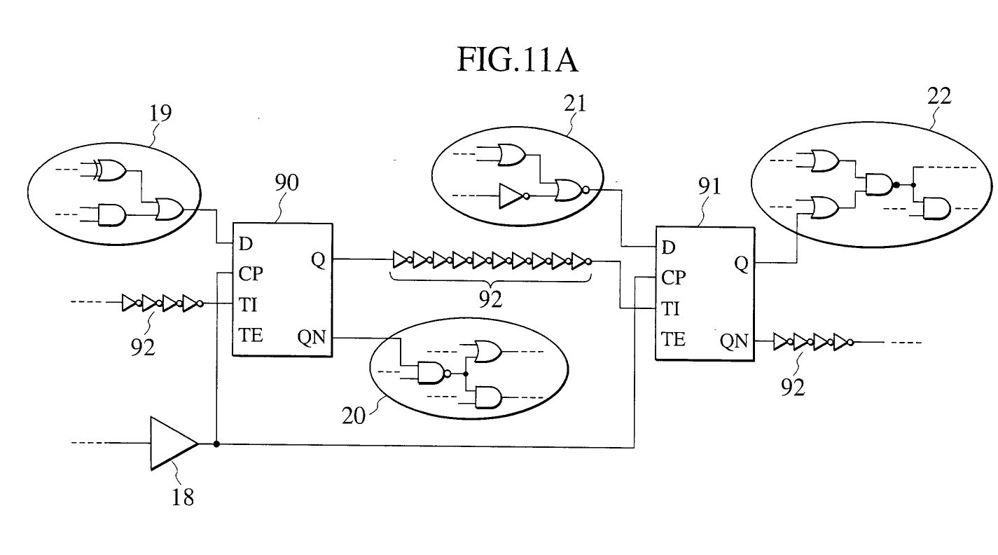

In the second embodiment of the present invention, shown in FIG. 4, a power reduction effect will be explained in detail as follows. FIG. 10A shows a circuit diagram where there is no delay element between a first-stage single-phase scan F/F 11X and a second-stage single-phase scan F/F 12Y. In FIG. 10A, the output terminal of the buffer circuit 18 is commonly connected to the clock input terminal CP of a single-phase scan F/F 11X and 12Y, respectively. FIG. 10B shows a circuit diagram where there is a delay element 14 between the first-stage single-phase scan F/F 11X and the second-stage single-phase scan F/F 12Y In FIG. 10B, the output terminal of the buffer circuit 18 is commonly connected to the clock input terminal CP of the single-phase scan F/F 11X and 12Y, respectively. And, the output data from the inverted output terminal QN of the first-stage single-phase scan F/F 11X is fed to the test input terminal TI of the second-stage single-phase scan F/F 11Y through the delay element 14.

In the following description, explanation is made based on the CMOS gate array technology having a 0.18 μm rule. In FIG. 10A and FIG. 10B, if the cell delay time Tx is 0.3 ns from the clock input terminal CP to inverted output terminal QN in the first-stage single-phase scan F/F 11X, and the holding time Ty is 0.15 ns in the second-stage single-phase scan F/F 11Y, the SKEW of 0.15 ns (0.3 ns-0.15 ns=0.15 ns) is allowable without any problem. That is, it is allowable, even if the clock timing of the first-stage single-phase scan F/F 11X is delayed up to 0.15 ns as compared with the clock timing of the second-stage single-phase scan F/F 11Y. However, for example, if the clock timing of the second-stage single-phase scan F/F 11Y is ahead by 0.5 ns as compared with the clock timing of the first-stage single-phase scan F/F 11X, that is SKEW=0.5 ns, the problem of holding violation will occur. In order to solve the problem of the holding violation, it is necessary to connect a delay element 14 between the inverted output terminal QN of the first-stage single-phase scan F/F 11X and the test input terminal TI of the second-stage single-phase scan F/F 11Y, having a delay time of 0.35 ns, that is 0.5 ns−0.15 ns=0.35 ns.

When the multistage inverter chain is utilized for the delay element 14, the number of stages A can be estimated to be A=12 by the equation 0.35<0.03×A, if the delay time of an inverter cell is 0.03 ns. Therefore, 12 stages inverter chain are allowable for the delay element 14. It is assumed that the value of energy dissipation of the first-stage single-phase scan F/F 11X is speculated as being 130 femto-joule (fJ), when the output terminal Q and/or QN of the first-stage single-phase scan F/F 11X is in switching mode. In the example shown in FIG. 10B, the delay element 14 will undergo switching when the first-stage single-phase scan F/F 11X is in switching mode. If the value of energy dissipation is 10 fJ for an inverter stage, the value of energy dissipation for a 12 stage inverter chain becomes 120 fJ, so that the value of energy dissipation of delay element 14 can be compared to the energy dissipation of the first-stage single-phase scan F/F 11X, when the output terminal Q and/or QN of the first-stage single-phase scan F/F 11X is in switching mode. Whenever the is first-stage single-phase scan F/F 11X is in switching mode, the delay element 14 is in switching mode as is shown in FIG. 10B. Therefore, the comparable value of energy dissipation is dissipated wastefully, when the output terminal Q and/or QN of the first-stage single-phase scan F/F 11X is in switching mode. Actually, if the clock timing of the first-stage single-phase scan F/F 11X is in advance of the clock timing of the second-stage single-phase scan F/F 11Y. The delay element 14 is not required. However, previously it has been difficult to specify which single-phase scan F/F will receive the clock signal at which timing in the logic design. Because of this, it is anticipated that the delay element 14 having a unique SKEW, which is predetermined by the circuit designer, is interconnected between all single-phase scan F/Fs. The output of the single-phase scan F/F does not always work. However, for the case shown in FIG. 10B, the power dissipation can be twice the original power dissipation of the first-stage single-phase scan F/F 11X in switching mode.

In the low power test circuit according to the second embodiment of the present invention, the AND gate is switched off by SE=0 signal thus leading to a non-scanning test mode, and switched on by SE=1 signal thus leading to a scanning test mode. Therefore, in the low power test circuit relating to the second embodiment of the present invention, the power dissipation level becomes comparable to the circuit without any delay element 14 such as is shown in FIG. 10A, because the delay element 14 in FIG. 4 does not work in non-scanning test mode. Therefore, very low power operation can be realized in the second embodiment of the present invention.

Third Embodiment

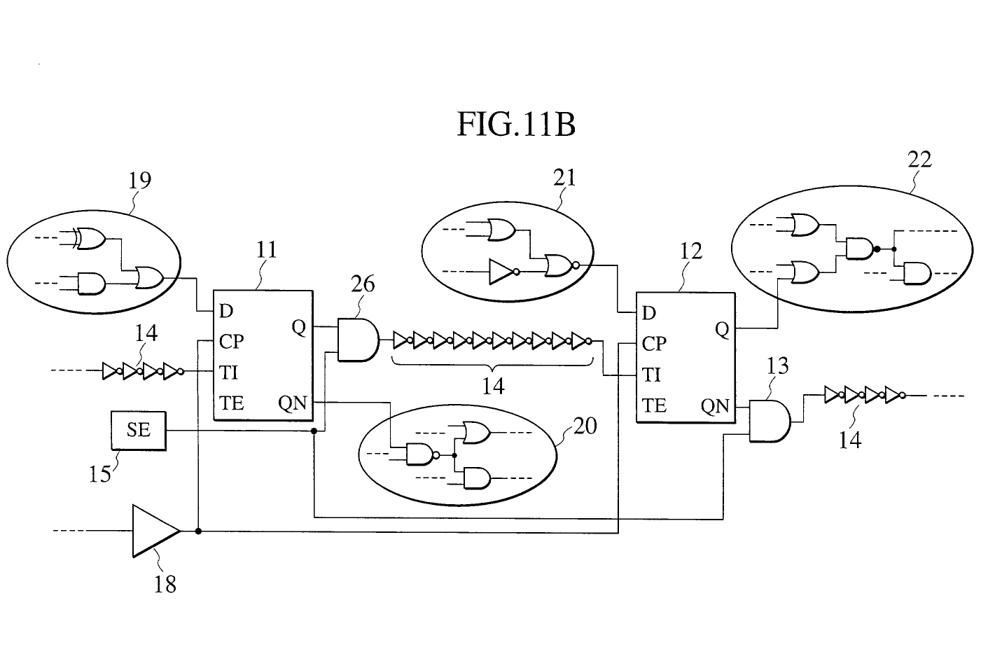

FIG. 11A shows a circuit diagram of a low power test circuit as a comparative example of the present invention. As shown in FIG. 11A, a low power test circuit has a delay element 92 for holding violation between the non-inverted output terminal Q of the first-stage single-phase scan F/F 90 and the test input terminal TI of the second-stage single-phase scan F/F 91. The logic circuit 20 is connected to the inverted output terminal QN of the first-stage single-phase scan F/F 90. The constitution of each element in FIG. 11A is similar to FIG. 1. In addition, the circuit operation in FIG. 11A is also similar to FIG. 1.

On the other hand, FIG. 11B shows a schematic circuit diagram of a low power test circuit related to the third embodiment of the present invention.

In FIG. 11B, output terminal Q of the first-stage single-phase scan F/F 11 is connected to an input terminal of the AND gate 26. On the other hand, the other input terminal of the AND gate 26 is connected to the scan enable terminal SE. An AND gate 26 and a delay element 14 encompassing an inverter chain are connected between test input terminal TI of the second-stage single-phase scan F/F 12 and output terminal Q of the first-stage single-phase scan F/F 11. If the third embodiment of the present invention shown in FIG. 11B is compared with a comparative example shown in FIG. 11A, the low power effect is clear.

In the third embodiment of the present invention as shown in FIG. 11B, low power operation is realized by means of the switching operation of the AND gate 26. In test scanning mode, SE=1, it enables the delay element 14 to be fully operated by the charging and discharging effect. In non-scanning mode, SE=0, the delay element 14 is isolated from the output terminal Q of the first-stage single-phase scan F/F 11. Therefore, a low power test circuit is realized in the circuit shown in FIG. 11B.

Fourth Embodiment

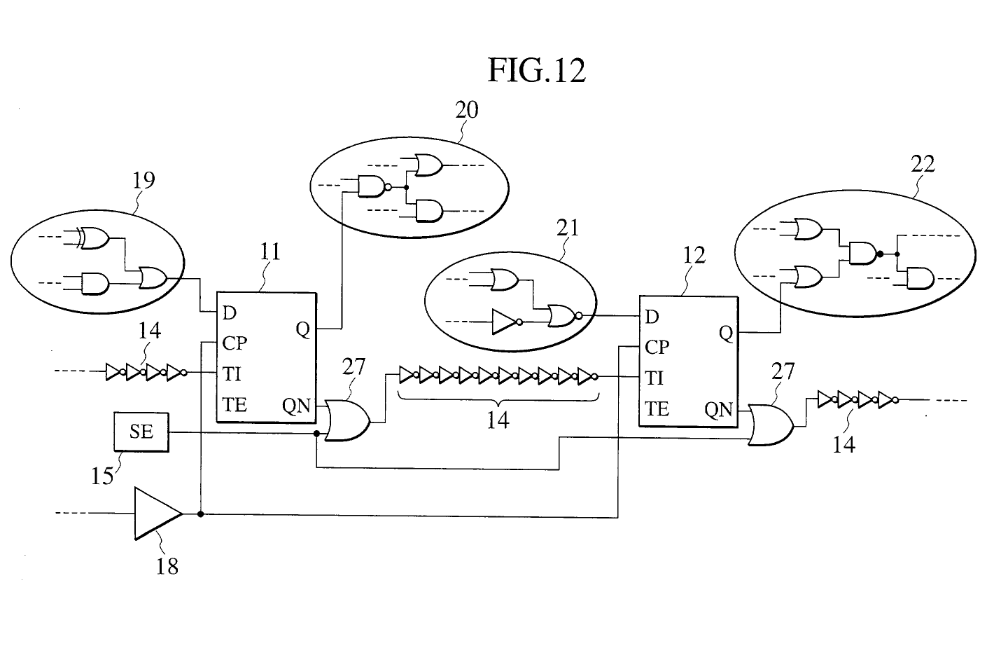

A low power test circuit in the fourth embodiment of the present invention, such as shown in FIG. 12, encompasses an OR gate 27 in place of an AND gate 13 in the second embodiment of the present invention shown in FIG. 4. It is a particular feature as shown in FIG. 12 that there be provided a low level signal to the scan enable terminal SE, SE=0, in scanning operational mode, and that a high level signal is provided to the scan enable terminal SE, SE=1, in non-scanning operational mode. The other circuit elements in FIG. 12 correspond to the elements in FIG. 4, respectively. In addition, the logic gate, which is connected between the inverted output terminal QN of the single-phase scan F/F 11, 12 and the input of the delay element 14, can be replaced by the logic gate other than the AND gate 13 or the OR gate 27. For example, a NAND gate or a NOR gate may also be employed.

Fifth Embodiment

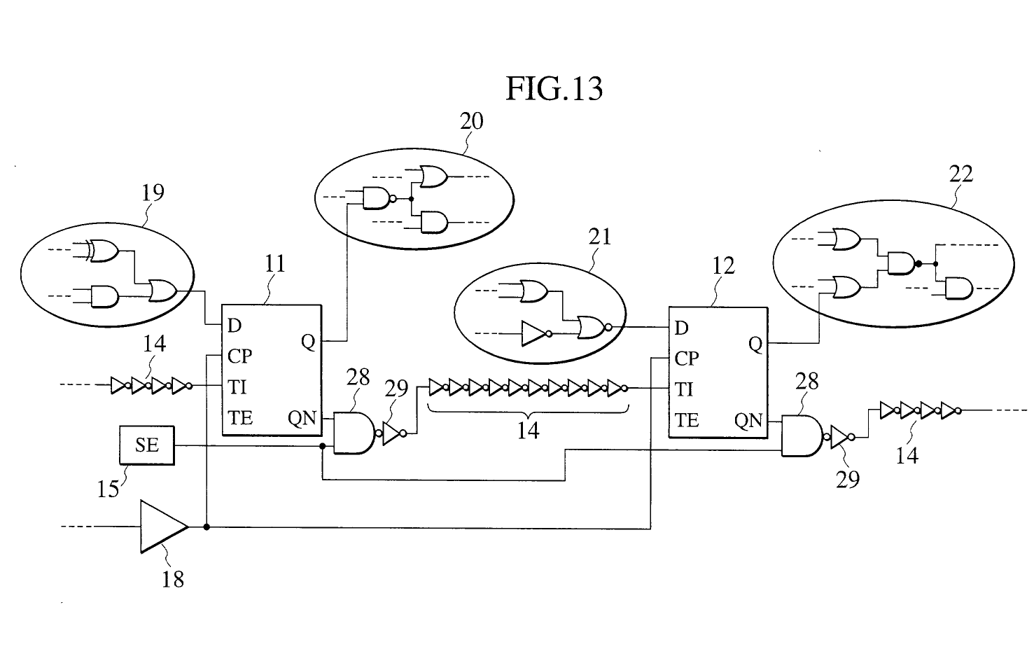

A low power test circuit in the fifth embodiment of the present invention, such as shown in FIG. 13, encompasses a logic gate circuit comprising a NAND gate 28 and an inverter 29 in place of an AND gate 13 in the second embodiment of the present invention shown in FIG. 4. In FIG. 13, a high level signal SE=1 is provided to the scan enable terminal SE 15 in scanning operational mode, and a low level signal SE=0 is provided to the scan enable terminal SE 15 in non-scanning operational mode. Therefore, the low power operation of the low power test circuit is realized by the switching operation of the NAND gate 28. The other circuit elements in FIG. 13 correspond to the elements in FIG. 4, respectively.

Sixth Embodiment

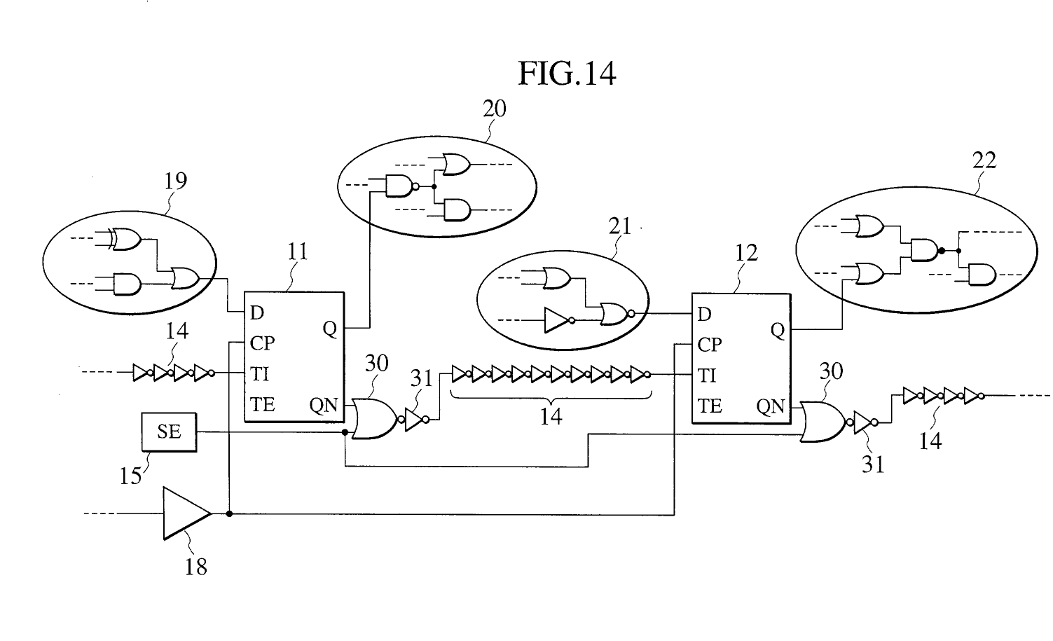

A low power test circuit in the sixth embodiment of the present invention, such as shown in FIG. 14, encompasses a logic gate circuit including a NOR gate 30 and an inverter 31 in place of an AND gate 13 in the second embodiment of the present invention shown in FIG. 4. In FIG. 14, a low level signal SE=0 is provided to the scan enable terminal SE 15 in scanning operational mode, and a high level signal SE=1 is provided to the scan enable terminal SE 15 in non-scanning operational mode. Therefore the low power operation of the low power test circuit is realized by the switching operation of the NOR gate 30. The other circuit elements in FIG. 14 correspond to the elements in FIG. 4, respectively.

Seventh Embodiment

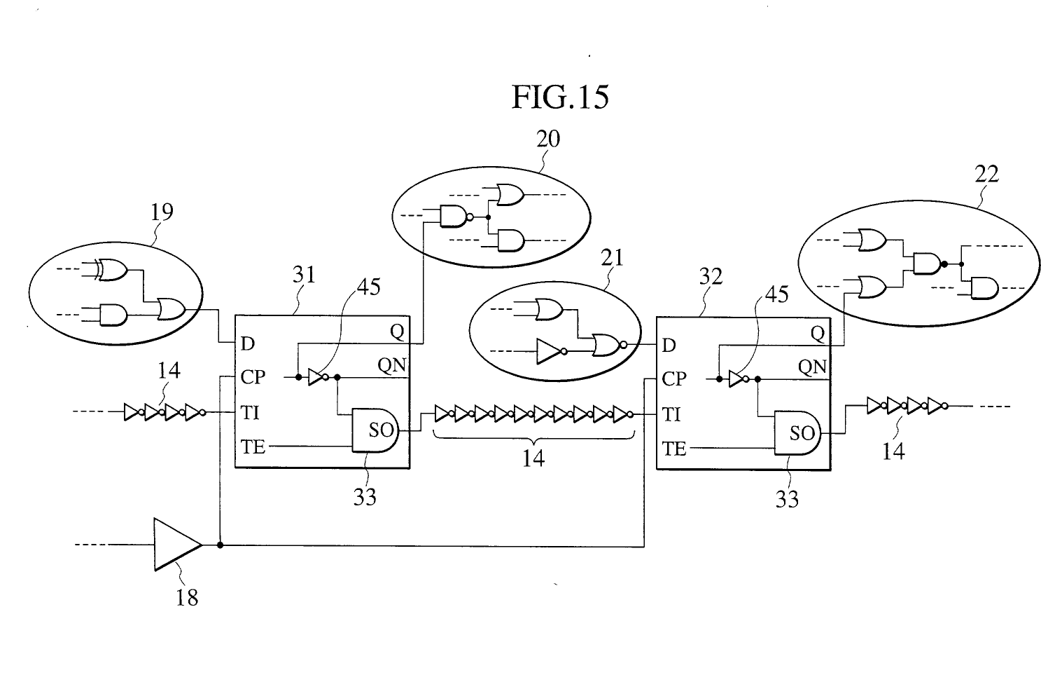

As shown in FIG. 15, a low power test circuit in the seventh embodiment of the present invention encompasses an AND gate 33 inside the single-phase scan F/F 31, 32. In the second embodiment of the present invention, an AND gate 13 is located outside the single-phase scan F/F 11, 12 as shown in FIG. 4. To one of the input terminals of the AND gate 33, there is provided a signal similar to the signal given on the test enable terminal TE of the single-phase scan F/F 31, 32. To another input terminal of the AND gate 33, there is provided a signal similar to the signal given on the inverted output terminal QN of the single-phase scan F/F 31, 32. The purpose of an inverter 45 is to invert the signal on the output terminal Q and give rise to the signal on the inverted output terminal QN. The output terminal of the AND gate 33 is connected to a scan out terminal SO of the single-phase scan F/F 31, 32. The scan out terminal SO is newly provided in the output of the single-phase scan F/F 31, 32, and it is connected to the input of the delay element 14, as shown in FIG. 15.

The low power operational effect can be realized in this seventh embodiment of the present invention as well as in the preceding first to sixth embodiments. Moreover, the layout pattern of the AND gate 33 is very close to the single-phase scan F/F 31, 32, because the AND gate 33 is inside the single-phase scan F/F 31, 32. On the other hand, it is considered that the layout pattern between the AND gate 13 and the single-phase scan F/F 11, 12 would be comparatively at a distance, in the second embodiment of the present invention, as is shown in FIG. 4. If the layout pattern between the AND gate 13 and the single-phase scan F/F 11, is at a distance, wiring connecting them would cause extra power dissipation due to the effect of charging and discharging. Therefore, the low-power operation is anticipated due to the reduction of the wiring capacitor in the seventh embodiment of the present invention, as shown in FIG. 15.

In FIG. 15, a high level signal TE=1 is provided to the test enable terminal TE 15 in scanning operational mode, and a low level signal TE=0 is provided to the test enable terminal TE 15 in non-scanning operational mode. Therefore, the low-power operation of the low power test circuit is realized by the switching operation of the AND gate 33. The other circuit elements in FIG. 15 correspond to the elements in FIG. 4, respectively.

In addition, for a modified example of the seventh embodiment of the present invention as shown in FIG. 15, another input terminal of the AND gate 33 may be connected to the output terminal Q in place of the inverted output terminal QN inside the single-phase scan F/F 31, 32, thus leading to transfer scan data from the output terminal Q of the single-phase scan F/F 31, 32.

Eighth Embodiment

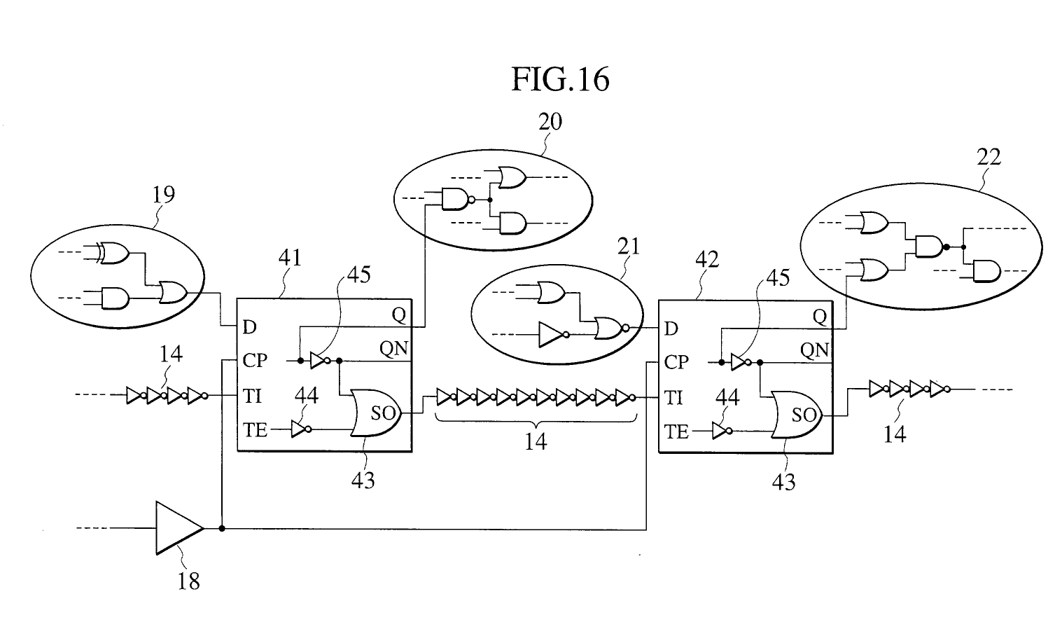

As shown in FIG. 16, a low power test circuit in the eighth embodiment of the present invention encompasses an OR gate 43 inside the single-phase scan F/F 41, 42. In the second embodiment of the present invention, an AND gate 13 is located outside the single-phase scan F/F 11, 12 as is shown in FIG. 4. To one of the input terminals of the OR gate 43, there is provided a signal inverted by the inverter 44 from the signal given on the test enable terminal TE of the single-phase scan F/F 41, 42. To another input terminal of the OR gate 43, there is provided a signal similar to the signal given on the single-phase scan F/F 41, 42. The purpose of an inverter 45 is to invert the signal on the output terminal Q and give rise to the signal on the inverted output terminal QN. The output terminal of the OR gate 43 is connected to the scan out terminal SO of the single-phase scan F/F 41, 42. The scan out terminal SO is newly provided in the output of the single-phase scan F/F 41,42, and it is connected to the input of the delay element 14, as shown in FIG. 16.

Moreover, the layout pattern of the OR gate 43 is very close to the single-phase scan F/F 41, 42, because the OR gate 43 is inside the single-phase scan F/F 41, 42. On the other hand, it is considered that the layout pattern between the AND gate 13 and the single-phase scan F/F 11, 12 would be comparatively at a distance, in the second embodiment of the present invention, as is shown in FIG. 4. If the layout pattern between the AND gate 13 and the single-phase scan F/F 11 is at a distance, wiring connecting would cause extra power dissipation due to the effect of charging and discharging. Therefore, the low-power operation is anticipated due to the reduction of the wiring capacitor in the eighth embodiment of the present invention, as shown in FIG. 16.

In FIG. 16, a high level signal TE=1 is provided to the test enable terminal TE 15 in scanning operational mode, and a low level signal TE=0 is provided to the test enable terminal TE 15 in non-scanning operational mode. Therefore, the low-power operation of the low power test circuit is realized by the switching operation of the OR gate 43. The other circuit elements in FIG. 16 correspond to the elements in FIG. 4, respectively. As described above, various types of low power test circuit can be designed by the introduction of various types of single-phase scan F/F s.

In addition, as for a modified example of the eighth embodiment as shown in FIG. 16, another input terminal of the OR gate 43 may be connected to the output terminal Q in place of the inverted output terminal QN inside the single-phase scan F/F 41,42, thus leading to output scan data from the output terminal Q of the single-phase scan F/F 41, 42.

Ninth Embodiment

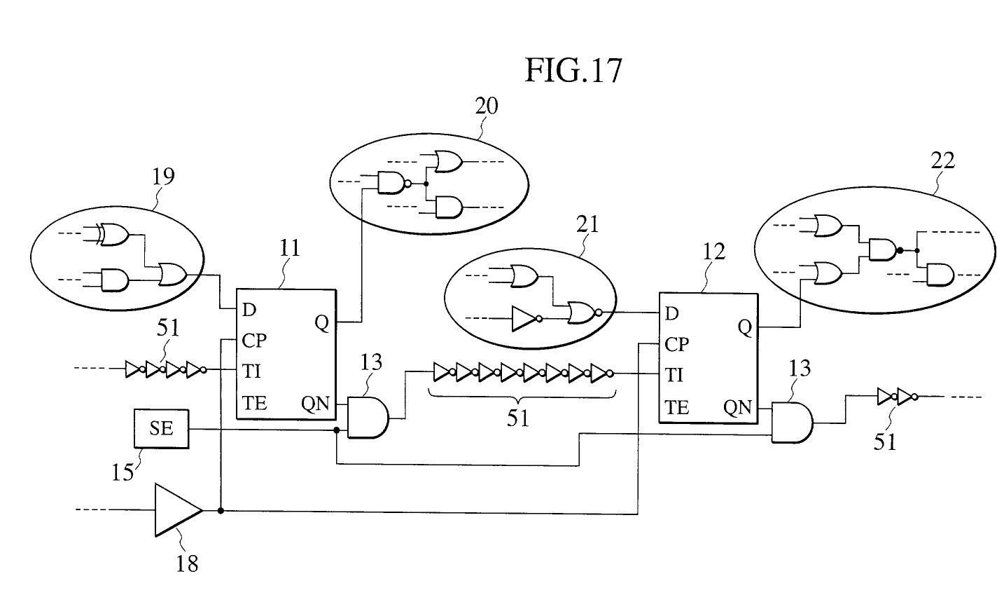

A delay element 51 reduces delay time in an AND gate 13 in a low power test circuit in the ninth embodiment of the present invention, as shown in FIG. 17. In the second embodiment as shown in FIG. 4, there is provided an AND gate 13 between the single-phase scan F/F 11, 12 and the delay element 14. The amount of the delay time will be increased by the introduction of the AND gate 13. It is considered that a delay of one stage of an AND gate will occur by the interposing of the AND gate 13. It is designed to have a minimum possible delay time between the inverted output terminal QN of the first stage single phase scan F/F 11 and the test input terminal TI of the second stage single phase scan F/F 12, in designing a delay time of the delay element 51 to have a reduced value corresponding to the delay time of the AND gate 13.

In FIG. 17, a high level signal SE=1 is provided to the scan enable terminal SE 15 in scanning operational mode, and a low level signal SE=0 is provided to the scan enable terminal SE 15 in non-scanning operational mode. Therefore, the low power operation of the low power test circuit is realized by the switching operation of the AND gate 13. The low power operational effect can be realized in this ninth embodiment of the present invention as well as in the preceding first to eighth embodiments. If the delay element 51 encompasses a buffer chain having a plurality of buffer circuits connected in series or encompasses an inverter chain having a plurality of inverters connected in series, the number of the buffers or the number of the inverters can be greatly reduced. The effect of reduction of the number of stages in the delay element 51 will give rise to the suppression of an increase in device area of the layout pattern. In fact, the increase in device area of the AND gate 13 is suppressed by reducing the number of the inverters. Therefore, the minimization of the device layout design is realized. In addition, the circuit design of the ninth embodiment of the present invention as described above can be applied to the other embodiments described in the third to the sixth embodiments of the present invention as shown in FIG. 11B to FIG. 14.

Tenth Embodiment

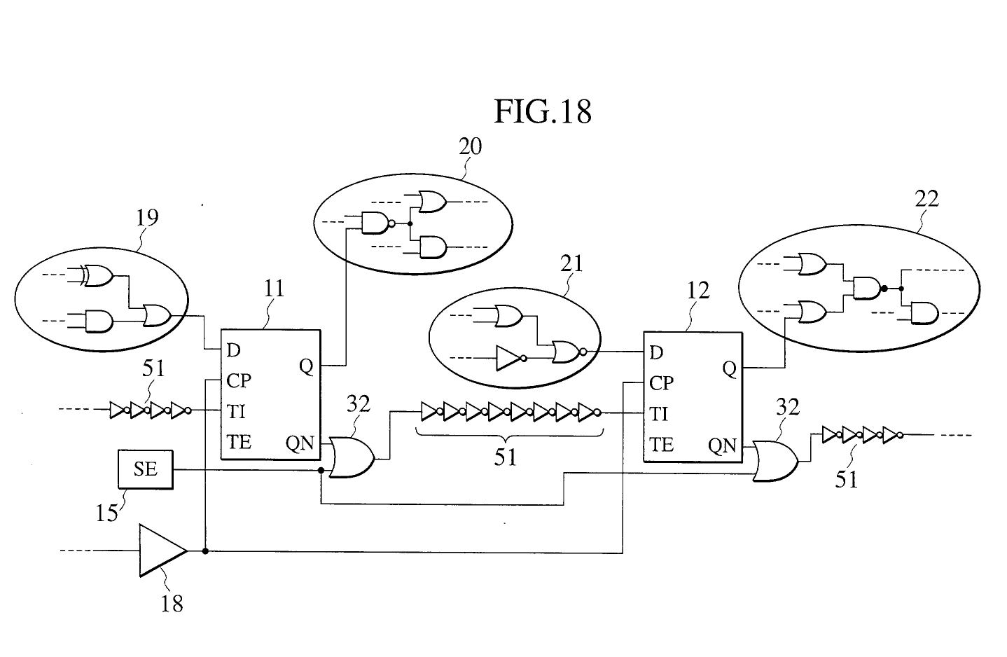

A low power test circuit in the tenth embodiment of the present invention such as shown in FIG. 18, encompasses a logic gate circuit having an OR gate 32 in place of an AND gate 13 in the ninth embodiment of the present invention shown in FIG. 17. The low power operational effect can be realized in this tenth embodiment of the present invention as well as in the preceding first to ninth embodiments. If the delay element 51 embraces a buffer chain having a plurality of buffer circuits connected in series or embraces an inverter chain having a plurality of inverters connected in series, the number of the buffers or the number of the inverters can be greatly reduced. The effect of reduction of the number of stages in the delay element 51 will give rise to the suppression of an increase in device area of the layout pattern. In fact, the increase in the device area of the OR gate 32 is suppressed by reducing the number of inverters. Therefore, the minimization of the device layout design is realized. In FIG. 18, a low level signal SE=0 is provided to the scan enable terminal SE 15 in scanning operational mode, and a high level signal SE=1 is provided to the scan enable terminal SE 15 in non-scanning operational mode. Therefore, the low power operation of the low power test circuit is realized by the switching operation of the OR gate 32.

Eleventh Embodiment

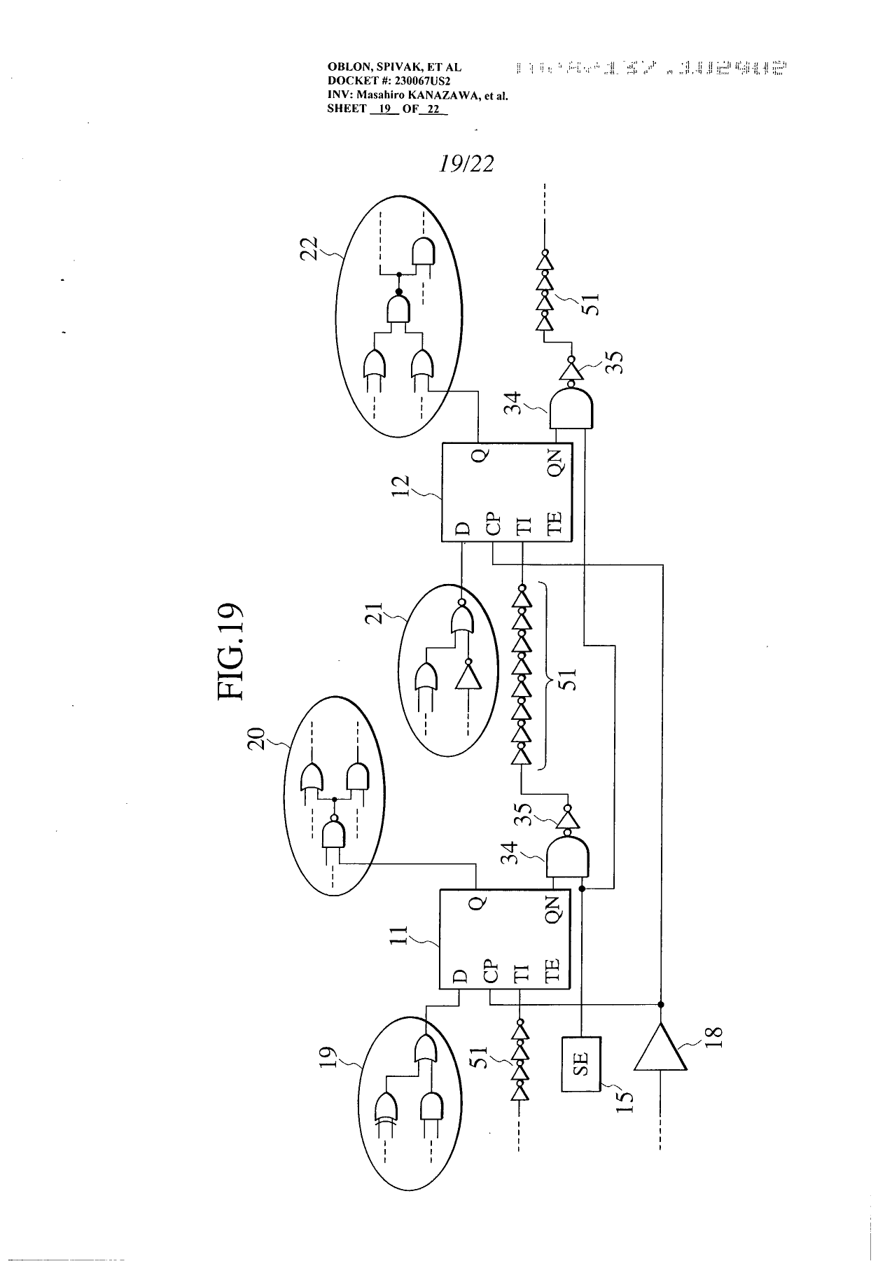

A low power test circuit in the eleventh embodiment of the present invention such as shown in FIG. 19, encompasses a logic gate circuit having a NAND gate 34 and an inverter 35 in place of an AND gate 13 in the ninth embodiment of the present invention shown in FIG. 17. The low power operational effect can be realized in this eleventh embodiment of the present invention as well as in the preceding first to tenth embodiments. If the delay element 51 encompasses a buffer chain having a plurality of buffer circuits connected in series or encompasses an inverter chain having a plurality of inverters connected in series, the number of the buffers or the number of the inverters can be greatly reduced. The effect of reduction of the number of stages in the delay element 51 will give rise to the suppression of an increase in device area of the layout pattern. In fact, an increase in device area of the NAND gate 34 and the inverter 35 is suppressed by reducing the number of inverters. Therefore, the minimization of the device layout design is realized. In FIG. 18, a high level signal SE=1 is provided to the scan enable terminal SE 15 in scanning operational mode, and a low level signal SE=0 is provided to the scan enable terminal SE 15 in non-scanning operational mode. Therefore, the low power operation of the low power test circuit is realized by the switching operation of the NAND gate 34.

Twelfth Embodiment

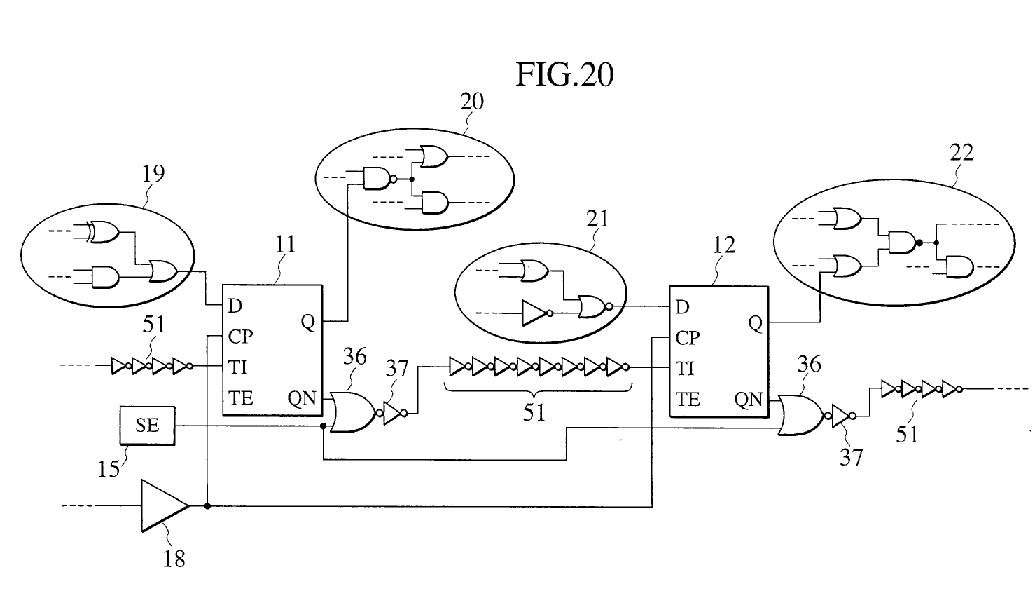

A low power test circuit in the twelfth embodiment of the present invention such as shown in FIG. 20, encompasses a logic gate circuit having a NOR gate 36 and an inverter 37 in place of the NAND gate 34 and the inverter 35 in the eleventh embodiment of the present invention shown in FIG. 19. The low power operational effect can be realized in this twelfth embodiment of the present invention as well as in the former embodiments from the first to the eleventh. If the delay element 51 includes a buffer chain having a plurality of buffer circuits connected in series or includes an inverter chain having a plurality of inverters connected in series, the number of buffers or the number of inverters can be greatly reduced. The effect of reduction of the number of stages in the delay element 51 will give rise to the suppression of an increase in device area of the layout pattern. In fact, an increase in device area of the NOR gate 36 and the inverter 37 is suppressed by reducing the number of the inverters. Therefore, the minimization of the device layout design is realized. In FIG. 20, a low level signal SE=0 is provided to the scan enable terminal SE 15 in scanning operational mode, and a high level signal SE=1 is provided to the scan enable terminal SE 15 in non-scanning operational mode. Therefore, the low power operation of the low power test circuit is realized by the switching operation of the NOR gate 36.

Thirteenth Embodiment

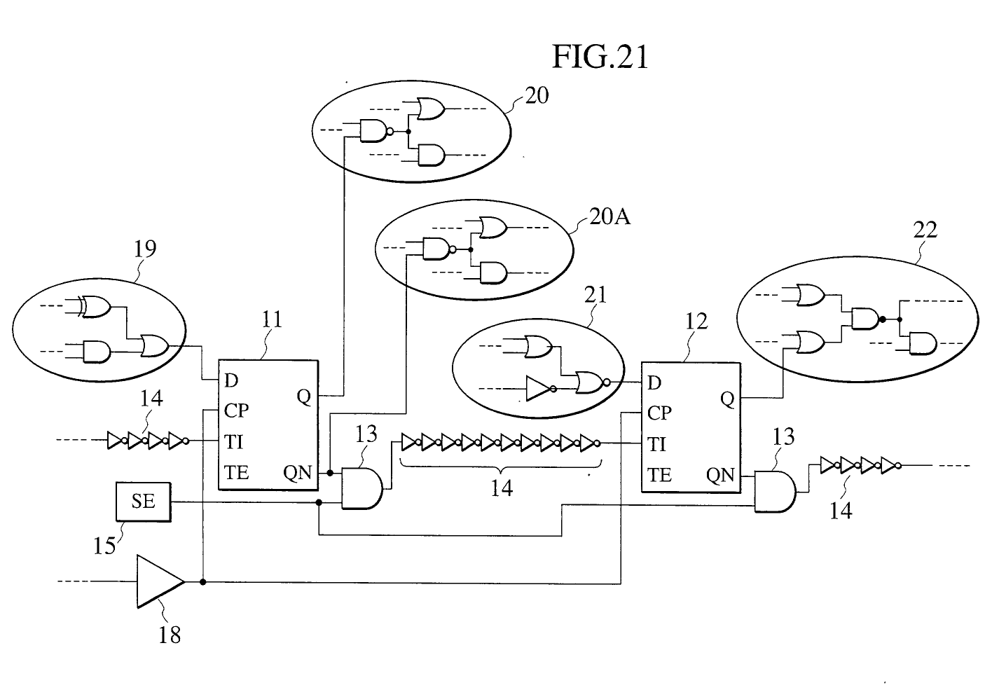

In a low power test circuit in the thirteenth embodiment of the present invention, such as shown in FIG. 21, an output data from an inverted output terminal QN of the single-phase scan F/F11 is diverted to another logic circuit 20A in the testing semiconductor IC, in addition to one of the input terminals of the AND gate 13. In such a thirteenth embodiment of the present invention, the output data appeared on the inverted output terminal QN of the single-phase scan F/F 11 can be utilized in normal mode. In FIG. 21, a high level signal SE=1 is provided to the scan enable terminal SE 15 in scanning operational mode, and a low level signal SE=0 is provided to the scan enable terminal SE 15 in non-scanning operational mode. Therefore, the low power operation of the low power test circuit is realized by the switching operation of the AND gate 13.

In addition, the circuit design of the thirteenth embodiment of the present invention as described above can be applied to the other embodiments described in the fourth to the sixth and the ninth to the twelfth embodiment of the present invention as shown in FIG. 12 to FIG. 14 and FIG. 17 to FIG. 20, respectively.

Fourteenth Embodiment

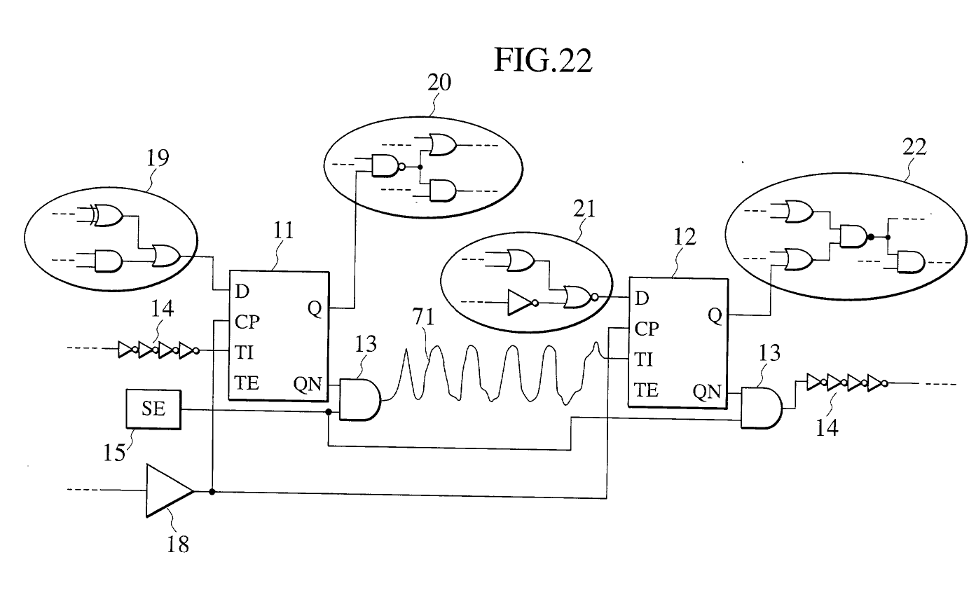

A low power test circuit in the fourteenth embodiment of the present invention such as is shown in FIG. 22, encompasses a wiring 71 in place of the delay element 14 in the second embodiment of the present invention shown in FIG. 4. In such a fourteenth embodiment of the present invention, the realization of a low power operational effect is anticipated without the use of a buffer chain or an inverter chain for a delay element. In FIG. 22, a high level signal SE=1 is provided to the scan enable terminal SE 15 in scanning operational mode, and a low level signal SE=0 is provided to the scan enable terminal SE 15 in non-scanning operational mode. Therefore, the low power operation of the low power test circuit is realized by the switching operation of the AND gate 13.

The scanning data given from the test input terminal TI of the single-phase scan F/F 11, 12 are delivered from the inverted output terminal QN of the single-phase scan F/F 11, 12. It may be delivered from the non-inverted output terminal Q of the single-phase scan F/F 11, 12. In this case, the circuit connection should be inverted between the inverted output terminal QN and the non-inverted output terminal Q in the single-phase scan F/F 11, 12.

Other Embodiments

Various modifications will become possible for those skilled in the art after receiving the teachings of the present disclosure without departing from the scope thereof.

What is claimed is:

1. A low power test circuit comprising:
a first stage single phase scan flip flop;
a second stage single phase scan flip flop;
a delay element located between an output terminal of the first stage single phase scan flip flop and an input terminal of the second stage single phase scan flip flop; and
a gate circuit connected between the output terminal of the first stage single phase scan flip flop and the delay element.

2. The low power test circuit of claim 1, wherein the gate circuit is an AND gate.

3. The low power test circuit of claim 1, wherein the gate circuit is an OR gate circuit.

4. The low power test circuit of claim 1, wherein the gate circuit is a NAND gate circuit.

5. The low power test circuit of claim 1, wherein the gate circuit is a NOR gate circuit.

6. The low power test circuit of claim 1, wherein the gate circuit is inside the first stage and/or the second stage single phase scan flip flop.

7. The low power test circuit of claim 2, wherein the AND gate is inside the first stage and/or the second stage single phase scan flip flop.

8. The low power test circuit of claim 3, wherein the OR gate is inside the first stage and/or the second stage single phase scan flip flop.

9. The low power test circuit of claim 1, wherein the delay element comprises an inverter chain having a plurality of inverters connected in series.

10. The low power test circuit of claim 1, wherein the delay element comprises a buffer chain having a plurality of buffer circuits connected in series.

11. The low power test circuit of claim 1, wherein the delay element reduces a delay time in the gate circuit.

12. The low power test circuit of claim 2, wherein the delay element reduces a delay time in the AND gate.

13. The low power test circuit of claim 3, wherein the delay element reduces a delay time in the OR gate.

14. The low power test circuit of claim 1, wherein the delay element comprises wiring.

15. The low power test circuit of claim 1, wherein the first stage and/or the second stage single phase scan flip flop comprises a multiplexer and a D type flip-flop.

16. The low power test circuit of claim 1, wherein the first stage and/or the second stage single phase scan flip flop comprises a multiplexer and a D type flip-flop with a reset terminal.

17. A low power test circuit comprising:
a first stage single phase scan flip flop;
a second stage single phase scan flip flop;
a delay element located between an output terminal of the first stage single phase scan flip flop and an input terminal of the second stage single phase scan flip flop;
a gate circuit connected between the output terminal of the first stage single phase scan flip flop and the delay element; and the gate circuit transferring scan data from the output terminal of the first stage single phase scan flip flop to the delay element in a scanning test mode, thus reducing power dissipation in the delay element.

18. A semiconductor integrated circuit with a low power test circuit comprising:
(a) a shift register comprising a plurality of single phase scan flip flops serially connected; and
(b) a low power test circuit comprising a first stage single phase scan is flip flop, a second stage single phase scan flip flop, a delay element located between an output terminal of the first stage single phase scan flip flop and an input terminal of the second stage single phase scan flip flop, a gate circuit connected between the output terminal of the first stage single phase scan flip flop and the delay element.

19. The semiconductor integrated circuit of claim 18, wherein the output terminal of the first stage single phase scan flip flop is an inverted output terminal.

20. The semiconductor integrated circuit of claim 18, wherein the output terminal of the first stage single phase scan flip flop is a non-inverted output terminal.
